(19) United States
(12) Patent Application Publication
(10) Pub. No.: US 2016/0014470 A1
(43) Pub. Date: Jan. 14, 2016

(54) Systems and Methods of Node Splitting

(71) Applicant: COX COMMUNICATIONS, INC., Atlanta, GA (US)

(72) Inventors: Kenneth L. Costner, Atlanta, GA (US); Denise T. McGhee, Marietta, GA (US); Connie Dufford, Marietta, GA (US); Andrew Sweet, Atlanta, GA (US)

(73) Assignee: COX COMMUNICATIONS, INC., Atlanta, GA (US)

(21) Appl. No.: 14/328,632

(22) Filed: Jul. 10, 2014

(51) Int. Cl. H04N 21/647; H04N 21/61; H04N 21/24; H04N 21/6338

(52) U.S. Cl. CPC H04N 21/64738; H04N 21/6338; H04N 21/6118; H04N 21/6168; H04N 21/2402; H04N 21/2408; H04N 21/2405

(57) ABSTRACT

Example embodiments of the systems and methods of node splitting disclosed herein aid designers and engineers in correctly selecting network nodes (such as hybrid fiber-coax (HFC) nodes) for splitting as well as the ability to split those nodes in the field for maximum efficiency. The systems and methods disclosed herein collect data from a variety of sources that are used as part of a criteria-based formula for determining which nodes have reached a maximum level of proper bandwidth usage and which are experiencing network stress, which could degrade the customer experience. Once these nodes are identified to be split, the nodes to be split may be re-designed to maximize network facilities, improve reliability, and reduce future split costs.

### TECHNICAL FIELD

The present disclosure is generally related to telecommunications and, more particularly, is related to nodal telecommunication architecture.

### BACKGROUND

A telecommunications network is a collection of terminal nodes, links and any intermediate nodes which are connected so as to enable telecommunication between the terminals. A physical network node is an active electronic device that is attached to a network, and is capable of sending, receiving, or forwarding information over a communications channel. In cable television systems (CATV), this term has assumed a broader context and is generally associated with a fiber optic node. This can be defined as those homes or businesses within a specific geographic area that are served from a common fiber optic receiver. A fiber optic node is generally described in terms of the number of “homes passed” that are served by that specific fiber node. A telecommunications network is a collection of nodes and links that is capable of carrying audio, visual, and data communications. While the term was once used to refer only to the collection of switches and wiring used by telephone service providers to provide audio connectivity to residential and business customers, it is now understood to include Internet, microwave, and wireless equipment as well as the more traditional forms of telephony. There are several different classes of telecommunication networks, with each of them having a slightly different focus.

The main function of any telecommunications network is to provide efficient transmission of information from a point of origin to a point of termination. When a transmission signal is initiated at a given point, with the signal routed through a series of nodes that may involve a combination of wired switches, Internet relays, and wireless nodes. The signal eventually terminates at a local switch, where is it then routed to the equipment used by the intended recipient. This process takes place within seconds, and establishes a connection that allows the parties to interact in a real-time fashion. The analysis and provisioning of the network presents many issues in attempts to maximize utilization of equipment. There are heretofore unaddressed needs with previous solutions.

### SUMMARY

Example embodiments of the present disclosure provide systems of node splitting. Briefly described, in architecture, one example embodiment of the system, among others, can be implemented as follows: one or more servers comprising at least one of: a physical network facility database; a customer address database; and a customer bandwidth usage database; a mapping application configured to apply data from the physical network facility database, the customer address database, and the customer bandwidth usage database; and a network node distribution module configured to determine network node distribution based on the data applied to the map.

Embodiments of the present disclosure can also be viewed as providing methods for node splitting. In this regard, one embodiment of such a method, among others, can be broadly summarized by the following steps: determining bandwidth utilization levels; determining if the utilization levels exceed predetermined criteria; applying utilization levels to a map populated with customer locations and physical equipment locations; and splitting network nodes based on the data in the map.

### BRIEF DESCRIPTION OF THE DRAWINGS

FIG. 1 is a system diagram of an example embodiment of a system of node splitting.

FIG. 2 is a flow diagram of an example embodiment of a method of node splitting.

FIG. 3 is a diagram of an example embodiment of the map used in the system of FIG. 1.

FIG. 4 is a diagram of an example embodiment of the map used in the system of FIG. 1.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Example embodiments of the systems and methods of node splitting disclosed herein aid designers and engineers in correctly selecting network nodes (such as hybrid fiber-coax (HFC) nodes) for splitting as well as the ability to split those nodes in the field for maximum efficiency. The systems and methods disclosed herein collect data from a variety of sources that are used as part of a criteria-based formula for determining which nodes have reached a maximum level of proper bandwidth usage and which are experiencing network stress, which could degrade the customer experience. Once these nodes are identified to be split, the nodes to be split may be re- designed to maximize network facilities, improve reliability, and reduce future split costs.

Example embodiments of the systems and methods of node splitting disclosed herein employ a modular design giving it the ability to grow in functionality and adjust for future architectures. Alternative embodiments may include a node bandwidth trending module, a budgeting module, and an ICOMS updating module.

Previously, each system carried out its own processes for selecting nodes to be split and how they were actually split in the field. As a result, there were as many processes as there are systems. While reviewing the history of node splits that occurred in various systems, it was noticed that there were instances of nodes being split improperly, which led to their being re-split multiple times before customer needs were met. Even then, the resulting network was often less efficient and more costly to operate.

Upon polling the field systems, it was discovered that each system was often using its own set of criteria for node split selection. There was little or no standardization or interaction between systems in determining proper criteria. National guidelines were often used concerning bandwidth utilization levels, but many other criteria, including some that are no longer relevant with today's architecture or technology, were still being used. This was especially true when it came to the actual node splitting in the field, where no solid guidelines were enforced.

Further research indicated that many sources of viable data in existence could be used for better selection of which nodes should be split and how to split those nodes. In addition to bandwidth utilization levels—customer equipment counts, customer service levels, network facility designs, and commercial needs, all in tabular and graphical formats—could be made available to the designers and engineers.

A majority of the focus during the process of node splitting is in the selection process. Most field offices used bandwidth contention levels as measured at the cable modem termination system (CMTS) service group blade. Some also used counts of modems/eMTAs in the field or customer counts of cable high speed Internet (CHSI) service or a combination of those two using utilization rates. Digital tuner counts, customers counts, telephony customer counts, amplifiers in cascade, switched digital usage, and even number of homes passed were also used in varying degrees. Some systems had developed their own formulas to weight the various criteria. Although systems may have slightly different network design requirements or service offerings, there should be standardization in the criteria and the threshold levels.

After selecting the nodes, the process of splitting the node in the field, had even less standardization. Due to the inability to integrate network data with customer data, systems often relied on “eye-balling” to determine where node splits would take place. Although many designers have a great familiarity with their local network facilities, important factors were not taken into consideration. Most field offices design node splits based on balancing existing HFC network legs, which allows for the least amount of re-design and cheapest near-term node split cost. However, that “cheap” node split today may be a less efficient design for network bandwidth usages and lead to more expensive, multiple splits in the future. Some systems saw the value of integrating customer service data into their node splitting process and went to such extremes as hand drawing hundreds of pieces of equipment onto network maps. Making all of the data available in a clear, easy platform became possible with example embodiments of the systems and methods of node splitting disclosed herein.

One concept that was previously stressed was the fact that the node selection process and node splitting process are two entirely separate functions. Taking that into account, it became clear that there should be two distinctly different criteria used when selecting which node to split vs. determining how to design for a node split.

In determining which nodes to split, example embodiments of the systems and methods disclosed herein employ upstream and downstream utilization rates, for example, as measured by the 95th percentile peak rate average at the CMTS interface as a primary criteria. Secondary criteria for selecting nodes to be split may include the number of network amplifiers in cascade. Nodes with a maximum cascade, for example, greater than 6 may be considered. Other secondary criteria may include the number of digital tuners assigned to the node. Also taken into consideration may be the potential addition of commercial business prospects. Commercial services may grow at a faster pace than residential services in the near future and add to network stress. Additional factors may include trouble tickets that reflect issues with network reliability and customer complaints that have been escalated and reflect customer dissatisfaction with quality of delivered services.

In order to create a fully functioning tool that automates the process of selecting node serving areas to be split, example embodiments of the disclosed systems and methods create a database that relates all service group blades to optical nodes served. A performance management application, for example Tivoli Netcool Performance Manager, monitors peak bandwidth rates on the network at a service group level. When a predetermined threshold is met requiring a “split”, the first step is to determine if the blade is functioning at a one-to-one ratio with optical receivers. If not, then the service blade may undergo a virtual split at a major telecom center (MTC) level. If the blade is already serving only one optical node, then that node may either be segmented or split in the field.

In example embodiments, one example indicator for determining a node split includes an interface bandwidth usage average peak rate, for example, when the 95th percentile exceeds 70%. In an example embodiment, to determine the bandwidth usage average peak rate, readings over a time period are recorded and the highest 5% of the readings are thrown out. The next highest reading is the 95^{th} percentile. If the reading at this 95th percentile is higher than 70% of the maximum potential (in bandwidth traffic) that a node can handle, the node is split. This may apply for both the upstream and downstream channels. Example embodiments of the systems and methods disclosed herein assign nodes a priority order based on the upstream and downstream peak usage rates, along with, as non-limiting examples, the rate of blocked requests from Video on Demand (VOD) customers and switched digital channels, nodes with greater than 750 digital video subscribers, nodes with greater than 5 amplifiers in cascade, the percentage rate of bandwidth usage growth over the past 3 months, and the number of customer complaints/trouble tickets.

Once a node has been identified as needing to be split in the field, example embodiments of the systems and methods of node splitting disclosed herein provide a geographical display of the node on a map. Included in the display may be the location of all relevant network facilities—optical nodes, node serving boundaries, amplifiers, coax cable routes, power supplies, and fiber sheath routes. In addition to network data, basic information such as street and highway locations, as well as all homes passed are available to be shown on the map. Then customer data including modem/eMTA locations and modem service levels, digital set-top box locations, and current commercial business customers, among other network related data may be displayed.

In example embodiments, designers select any individual object on the map and receive the data related to the object. For example, by selecting an amplifier, the designer may see the total cascade count within the network. Selecting a modem allows the designer to see what CHSI service level the customer subscribes to and monthly bandwidth usage totals. By selecting a business customer, the monthly recurring charges (monthly revenue) amount and service level are visible. These all provide the designer with a wealth of information to use when deciding how to “right-size” the new nodes.

Example embodiments disclosed herein also allow the designer to aggregate any of the tabular data sets. This allows a user to create on-the-fly test designs and sum up equipment counts and service levels. Individual bandwidth reading reports allow a designer to access bandwidth usage totals by monthly billing cycle and by individual peak rates. Example embodiments of the systems and methods of node splitting disclosed herein enable a balance of bandwidth demands down to the point of an individual customer.

A service area in telecommunications may be referred to as a node. A node can serve an area the size of a neighborhood, which could include 500 to 1000 homes. Excessive traffic may be serviced by that node, for example, from high data bandwidth uses such as streaming movies over the internet, a service that has grown significantly over the past several years. Example embodiments of the systems and methods of node splitting disclosed herein provide a layout of that node to determine the physical layer characteristics, including the location of the cable, the location of the amplifier, and the location of the node, among other physical layers characteristics. Example embodiments also provide customer locations, including locations of data customers, video customers, cable TV customers, internet customers and telephony customers, among others. Any or all of these customer characteristics may be mapped in relation to the physical network characteristics.

Also, in example embodiments, individual bandwidth reports, which register how much bandwidth a customer's modem is using so that, not only can the physical locations of the customers be provided, but the actual bandwidth consumption within the network may be included. With the disclosed embodiments, a designer may access a map of a node to view the physical layout, the customer locations, and then to propose a location for a new node in real time.

If a node needs to be split, the designer may determine if it may be split again into two nodes, or to three, four, five, etc. to determine the size and how the bandwidth use. The designer may determine where the node should be split and into how many sub-nodes it should be split. Every node has a particular level of bandwidth usage or consumption limit, for example 70%. If a node's bandwidth consumption level rises above 70%, then bottlenecking issues may occur. The disclosed example embodiments allow for the targeting of the correct nodes to split, targeting the correct way to split them, and ensuring balance of the bandwidth on the nodes.

An engineering application such as GNIS may be used to provide the physical layer information such as the coverage boundaries for the node, the optical receiver location, and the cable and power supply location, the splitter location, and amplifier location,. The customer data may be provided by an application such as ICOMS, which may provide a master customer address database that may be matched to the physical layer information provided by the engineering application. Then bandwidth consumption of customers may be matched in with the other two databases. The aggregate of the three databases may then be analyzed to determine a node splitting plan.

In previous solutions, when a node reached 1000 homes, for example, with an architecture with only a single amplifier, that one node may comprise three or four sub-nodes (more advanced nodes) but, there was no way to determine which of those out of those 3 or 4 to split. Example embodiments of the systems and methods of node splitting disclosed herein allow a designers to test those 3 or 4 new sub-nodes and determine which one has the highest contention levels, which ones may be split to maximize utilization.

Each node may have both upstream and downstream bandwidth utilization levels. Downstream refers to a signal coming from the internet, for example, a user downloading a page, receiving an email, watching a video, etc. Upstream refers to a signal sent to the internet, for example, a user posting a picture on her Facebook page. If either upstream or downstream reach 70% utilization, the node may be flagged, indicating that this node has an issue. Likewise, with digital video and Video On Demand, in a high use situation, with many customers trying to watch a movie On Demand trying to watch 100 different channels, a problem with the video side of the network may cause a red flag as well. A high use situation may cause a flag from a one-time over-limit situation, or it could be from an averaged over-limit situation over a time period.

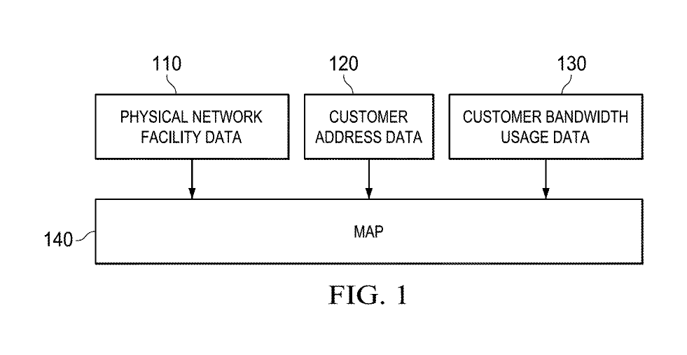

FIG. 1 provides a system diagram of an example embodiment of a system of node splitting. One or more servers store physical network facility data database 110, customer address data database 120 and customer bandwidth usage data database 130. The data from one or more of physical network facility data database 110, customer address data database 120 and customer bandwidth usage data database 130 are applied to map 140. A designer may then use the data provided on the map to determine how to split the nodes.

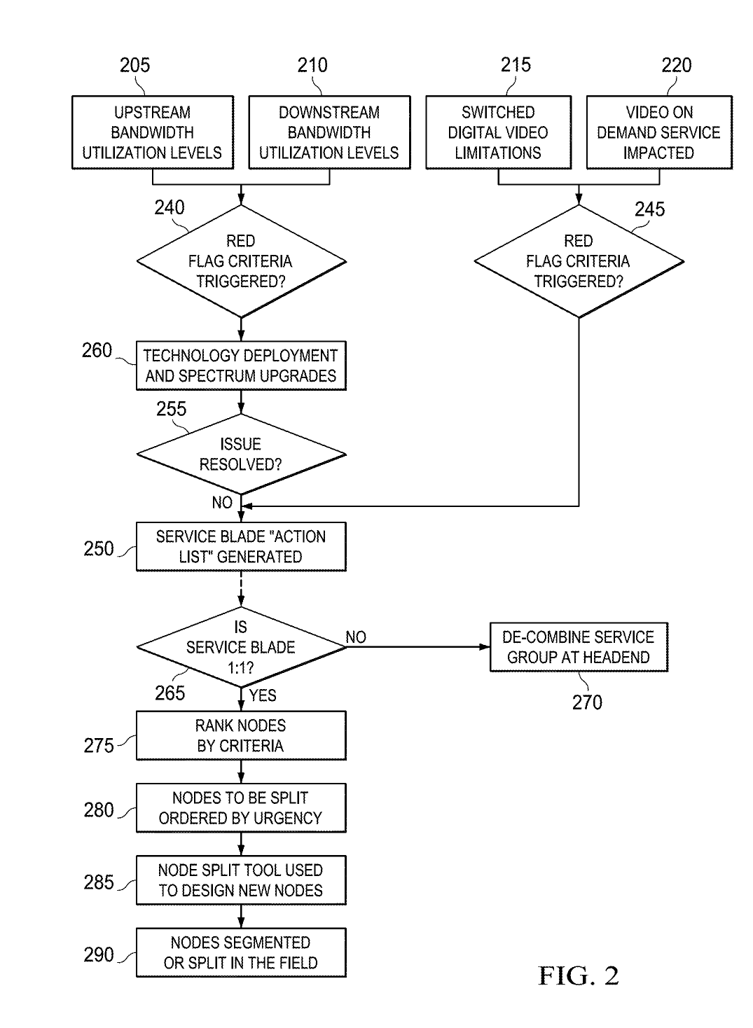

FIG. 2 provides a flow chart of an example embodiment of a method of node splitting. In block 205, upstream bandwidth utilization levels are determined. In block 210, downstream bandwidth levels are determined. In block 240, the upstream and downstream levels are compared to first predetermined red flag criteria. When the red flag criteria threshold is reached, in block 260, technology deployment and spectrum upgrades are employed. In block 255, if the issue is resolved from the technology deployment and spectrum upgrades of block 260, the utilization levels are periodically examined for further utilization issues.

In block 215, switched digital video limitations are examined. In block 220, video on demand service impact is examined. In block 245, the switched digital video limitations and video on demand service impact are compared to second predetermined red flag criteria. When the first or second red flag criteria are met and not resolved, in block 250, a service blade action list is generated. In block 265, a determination is made as to whether the service blade is at a 1:1 correspondence. If it is not at 1:1, then at block 270, the service group is de-combined at the headend. If it is at 1:1, then in block 275, the nodes are ranked by criteria. In block 280, nodes are split in order of urgency as determined by the ranking in block 275. In block 285, example embodiments of the system of node splitting disclosed herein are used to design new nodes. In block 290, the nodes are segmented or split in the field.

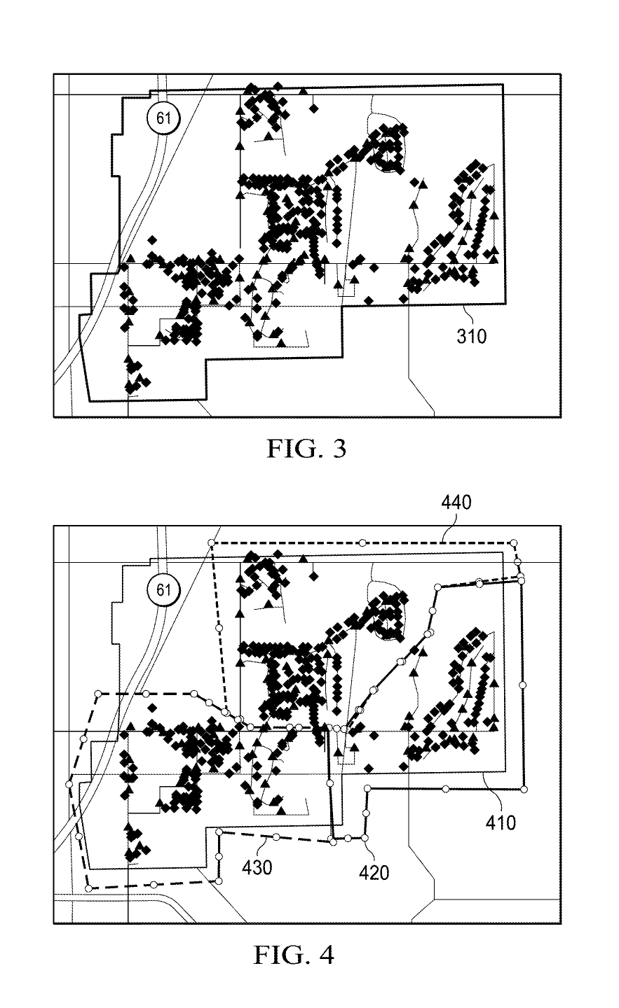

FIG. 3 provides a pictorial view of map 310 populated with data from physical network facility database 110, customer address database 120, and customer bandwidth usage database 130.

FIG. 4 provides map 410 in which map 310 has been analyzed and node utilization has been determined. Based on the analysis as deployed in example embodiments provided above, the map has been divided into sections 420, 430, and 440 such that each section is covered by an separate node or node cluster.

The flow chart of FIG. 2 shows the architecture, functionality, and operation of a possible implementation of the node splitting software. In this regard, each block represents a module, segment, or portion of code, which comprises one or more executable instructions for implementing the specified logical function(s). It should also be noted that in some alternative implementations, the functions noted in the blocks may occur out of the order noted in FIG. 2. For example, two blocks shown in succession in FIG. 2 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present invention has been described in detail, it should be understood that various changes, substitutions and alterations can be made thereto without departing from the spirit and scope of the invention as defined by the appended claims.

Therefore, at least the following is claimed:

1. A system comprising:
one or more servers comprising at least one of:
a physical network facility database;
a customer address database; and
a customer bandwidth usage database;
a mapping application configured to apply data from the physical network facility database, the customer address database, and the customer bandwidth usage database; and
a network node distribution module configured to determine network node distribution based on the data applied to the map.

2. The system of claim 1, further comprising a node splitting tool configured to split nodes based on the determined network node distribution.

3. The device of claim 2, wherein the network node distribution module is further configured to rank nodes based on utilization levels.

4. The device of claim 3, wherein the utilization levels comprise at least one of upstream and downstream bandwidth utilization levels.

5. The device of claim 3, wherein utilization levels comprise at least one of switched digital video limitation level and video on demand service impact level.

6. The device of claim 2, wherein the nodes are split based on urgency.

7. A method, comprising:
determining bandwidth utilization levels;
determining if the utilization levels exceed predetermined criteria;
applying utilization levels to a map populated with customer locations and physical equipment locations; and
splitting network nodes based on the data in the map.

8. The method of claim 7, further comprising ranking nodes based on utilization levels.

9. The method of claim 8, wherein the utilization levels comprise at least one of upstream and downstream bandwidth utilization levels.

10. The method of claim 7, wherein utilization levels comprise at least one of switched digital video limitation level and video on demand service impact level.

11. The method of claim 7, further comprising splitting the nodes based on urgency.

12. The method of claim 7, further comprising splitting the nodes based on the determined network node distribution.

13. The method of claim 7, further comprising segmenting or splitting the nodes in the field.

14. A tangible computer readable medium comprising instructions for performing steps for:
determining bandwidth utilization levels;
determining if the utilization levels exceed predetermined criteria;
applying utilization levels to a map populated with customer locations and physical equipment locations; and
splitting network nodes based on the data in the map.

15. The computer readable medium of claim 14, further comprising instructions for ranking nodes based on utilization levels.

16. The computer readable medium of claim 15, wherein the utilization levels comprise at least one of upstream and downstream bandwidth utilization levels

17. The computer readable medium of claim 15, wherein utilization levels comprise at least one of switched digital video limitation level and video on demand service impact level.

18. The computer readable medium of claim 14, further comprising instructions for splitting the nodes based on urgency.

19. The computer readable medium of claim 14, further comprising instructions for splitting the nodes based on the determined network node distribution.

20. The computer readable medium of claim 14, further comprising instructions for segmenting or splitting the nodes in the field.
